(19) United States
(12) Patent Application Publication
(10) Pub. No.: US 2019/0129989 A1
(43) Pub. Date: May 2, 2019

(54) Automated Database Configurations for Analytics and Visualization of Human Resources Data

(71) Applicant: SAP SE, Walldorf (DE)

(72) Inventors: Jenngang Shih, Sunnyvale, CA (US); Mirza Kopic, Walldorf (DE); Ozcan Bircan, San Francisco, CA (US); Rajesh Vittal, San Francisco, CA (US); Maria Clarisse Cornet, San Francisco, CA (US); Mengxiao Han, Shanghai (CN)

(21) Appl. No.: 15/800,750

(22) Filed: Nov. 1, 2017

(51) Int. Cl. G06F 17/30; G06Q 10/10

(52) U.S. Cl. CPC G06F 17/30365; G06F 17/30368; G06N 7/005; G06Q 10/105; G06F 17/30103; G06F 17/30076

(57) ABSTRACT

Under one aspect, an automated data configuration engine receives first and second sets of files that are from respective companies, include unique employee identifiers for employees respectively employed on first and second dates, and can have different formats than one another. The automated data configuration engine parses each file of the first and second sets of files to extract portions of those files corresponding to the unique employee identifiers, and generates first and second sets of database entries for each of the companies including the extracted portions and the respective first or second dates. The automated data configuration engine also obtains employee termination data for each of the respective companies; and generates a third set of database entries for each of the companies including the employee termination data of the respective company.

### TECHNICAL FIELD

The subject matter described herein relates to database configurations for analytics and visualization of data.

### BACKGROUND

Different companies can manage human resources data, such as employee data, in different ways. For example, they can store their human resources data in different types of databases, and in different formats, than one another. Additionally, different companies can store different types of employee data than one another. For example, many companies may store data about who is employed at a given time and their respective salaries, but companies may or may not store data about employee ages. Differences between human resources data can pose technological barriers to analyzing such data.

### SUMMARY

Automated database configurations for analytics and visualization of human resources data are provided herein.

Under some aspects, a method is provided that includes receiving, by an automated data configuration engine operating on one or more data processors, a first set of files from a plurality of respective companies. The files of the first set of files respectively can include unique identifiers for employees employed in respective jobs at respective ones of the companies on respective first dates. At least some of the files of the first set of files can have different formats than one another. The method also can include receiving, by the automated data configuration engine, a second set of files from the plurality of respective companies. The files of the second set of files respectively can include unique identifiers for employees employed in respective jobs at respective ones of the companies on respective second dates. At least some of the files of the second set of files can have different formats than one another. The method also can include parsing, by the automated data configuration engine, each file of the first set of files to extract portions of that file corresponding to the unique identifiers of employees for the employees employed in the respective jobs at the respective ones of the companies on the respective first dates. The method also can include parsing, by the automated data configuration engine, each file of the second set of files to extract portions of that file corresponding to the unique identifiers of employees for the employees employed in the respective jobs at the respective ones of the companies on the respective second dates. The method also can include generating, by the automated data configuration engine, a first set of database entries for each of the respective companies. Each database entry of the first set of database entries can include an extracted portion of the files of the first set of files and the respective first date. The method also can include generating, by the automated data configuration engine, a second set of database entries for each of the respective companies. Each database entry of the second set of database entries can include an extracted portion of the files of the second set of files and the respective second date. The method also can include obtaining, by the automated data configuration engine, employee termination data for each of the respective companies; and generating, by the automated data configuration engine, a third set of database entries for each of the companies. Each database entry of the third set of database entries can include the employee termination data of the respective company.

In some configurations, files of the first and second sets of files include flat files.

In some configurations, the first set of database entries for each company respectively includes a first column including the unique identifiers for employees employed by that company on the respective first dates and a second column including the respective first dates. The second set of database entries for each company respectively can include a third column including the unique identifiers for employees employed by that company on the respective second dates and a fourth column including the respective second dates. The first, second, third, and fourth columns can be located in the same positions for each respective company.

In some configurations, at least some files of the first and second files further include, for each employee, one or more employee descriptors selected from the group consisting of an identifier of the job of that employee, an age of that employee, a tenure of that employee at the respective company, a salary of that employee, an employment type of that employee, and a potential rating of that employee. The method further can include generating, by the automated data configuration engine, a fourth set of database entries for each of the companies. Each database entry of the fourth set of database entries can include one of the one or more employee descriptors. Optionally, the method further includes selecting, by an analytics engine operating on one or more data processors, based on the third and fourth sets of database entries, one or more of the employee descriptors as being relatively highly correlated with employee departure from the company. The method further can include generating, by the analytics engine, based on the third and fourth sets of database entries, a value representing a power of the one or more employee descriptors for predicting employee departure from the company. In some configurations, the method further can include generating, by a visualization engine operating on one or more data processors, a graphical representation of the selected one or more of the employee descriptors overlaid with the respective powers of those employee descriptors. In some configurations, the analytics engine includes a machine learning model trained using a training set of database entries based on portions of the third and fourth sets of database entries, and a test set of database entries based on other portions of the third and fourth sets of database entries.

Under another aspect, a computer system is provided that includes at least one data processor; and memory storing instructions which, when executed by the at least one data processor, result in operations. The operations can include receiving, by an automated data configuration engine, a first set of files from a plurality of respective companies. The files of the first set of files respectively can include unique identifiers for employees employed in respective jobs at respective ones of the companies on respective first dates. At least some of the files of the first set of files can have different formats than one another. The operations further can include receiving, by the automated data configuration engine, a second set of files from the plurality of respective companies. The files of the second set of files respectively can include unique identifiers for employees employed in respective jobs at respective ones of the companies on respective second dates. At least some of the files of the second set of files can have different formats than one another. The operations further can include parsing, by the automated data configuration engine, each file of the first set of files to extract portions of that file corresponding to the unique identifiers of employees for the employees employed in the respective jobs at the respective ones of the companies on the respective first dates. The operations further can include parsing, by the automated data configuration engine, each file of the second set of files to extract portions of that file corresponding to the unique identifiers of employees for the employees employed in the respective jobs at the respective ones of the companies on the respective second dates. The operations further can include generating, by the automated data configuration engine, a first set of database entries for each of the respective companies. Each database entry of the first set of database entries can include an extracted portion of the files of the first set of files and the respective first date. The operations further can include generating, by the automated data configuration engine, a second set of database entries for each of the respective companies. Each database entry of the second set of database entries can include an extracted portion of the files of the second set of files and the respective second date. The operations further can include obtaining, by the automated data configuration engine, employee termination data for each of the respective companies; and generating, by the automated data configuration engine, a third set of database entries for each of the companies. Each database entry of the third set of database entries can include the employee termination data of the respective company.

In some configurations, files of the first and second sets of files include flat files.

In some configurations, the first set of database entries for each company respectively includes a first column including the unique identifiers for employees employed by that company on the respective first dates and a second column including the respective first dates. The second set of database entries for each company respectively can include a third column including the unique identifiers for employees employed by that company on the respective second dates and a fourth column including the respective second dates. The first, second, third, and fourth columns can be located in the same positions for each respective company.

In some configurations, at least some files of the first and second files further can include, for each employee, one or more employee descriptors selected from the group consisting of an identifier of the job of that employee, an age of that employee, a tenure of that employee at the respective company, a salary of that employee, an employment type of that employee, and a potential rating of that employee. The instructions, when executed by the at least one data processor, further can result in operations that include generating, by the automated data configuration engine, a fourth set of database entries for each of the companies. Each database entry of the fourth set of database entries can include one of the one or more employee descriptors. The instructions, when executed by the at least one data processor, further can result in operations that include selecting, by an analytics engine, based on the third and fourth sets of database entries, one or more of the employee descriptors as being relatively highly correlated with employee departure from the company. The operations further can include generating, by the analytics engine, based on the third and fourth sets of database entries, a value representing a power of the one or more employee descriptors for predicting employee departure from the company. Optionally, the instructions, when executed by the at least one data processor, further result in operations that include generating, by a visualization engine, a graphical representation of the selected one or more of the employee descriptors overlaid with the respective powers of those employee descriptors. Optionally, the analytics engine can include a machine learning model trained using a training set of database entries based on portions of the third and fourth sets of database entries, and a test set of database entries based on other portions of the third and fourth sets of database entries.

Under yet another aspect, a non-transitory computer-readable medium is provided storing instructions which, when executed by at least one data processor of a computer system, result in operations. The operations can include receiving, by an automated data configuration engine, a first set of files from a plurality of respective companies. The files of the first set of files respectively can include unique identifiers for employees employed in respective jobs at respective ones of the companies on respective first dates. At least some of the files of the first set of files can have different formats than one another. The operations further can include receiving, by the automated data configuration engine, a second set of files from the plurality of respective companies. The files of the second set of files respectively can include unique identifiers for employees employed in respective jobs at respective ones of the companies on respective second dates. At least some of the files of the second set of files can have different formats than one another. The operations further can include parsing, by the automated data configuration engine, each file of the first set of files to extract portions of that file corresponding to the unique identifiers of employees for the employees employed in the respective jobs at the respective ones of the companies on the respective first dates. The operations further can include parsing, by the automated data configuration engine, each file of the second set of files to extract portions of that file corresponding to the unique identifiers of employees for the employees employed in the respective jobs at the respective ones of the companies on the respective second dates. The operations further can include generating, by the automated data configuration engine, a first set of database entries for each of the respective companies. Each database entry of the first set of database entries can include an extracted portion of the files of the first set of files and the respective first date. The operations further can include generating, by the automated data configuration engine, a second set of database entries for each of the respective companies. Each database entry of the second set of database entries can include an extracted portion of the files of the second set of files and the respective second date. The operations further can include obtaining, by the automated data configuration engine, employee termination data for each of the respective companies; and generating, by the automated data configuration engine, a third set of database entries for each of the companies. Each database entry of the third set of database entries can include the employee termination data of the respective company.

In some configurations, files of the first and second sets of files include flat files.

In some configurations, the first set of database entries for each company respectively includes a first column including the unique identifiers for employees employed by that company on the respective first dates and a second column including the respective first dates. The second set of database entries for each company respectively can include a third column including the unique identifiers for employees employed by that company on the respective second dates and a fourth column including the respective second dates. The first, second, third, and fourth columns can be located in the same positions for each respective company.

In some configurations, at least some files of the first and second files further can include, for each employee, one or more employee descriptors selected from the group consisting of an identifier of the job of that employee, an age of that employee, a tenure of that employee at the respective company, a salary of that employee, an employment type of that employee, and a potential rating of that employee. The instructions, when executed by the at least one data processor, further can result in operations that include generating, by the automated data configuration engine, a fourth set of database entries for each of the companies. Each database entry of the fourth set of database entries can include one of the one or more employee descriptors. The instructions, when executed by the at least one data processor, further can result in operations that include selecting, by an analytics engine, based on the third and fourth sets of database entries, one or more of the employee descriptors as being relatively highly correlated with employee departure from the company. The operations further can include generating, by the analytics engine, based on the third and fourth sets of database entries, a value representing a power of the one or more employee descriptors for predicting employee departure from the company. Optionally, the instructions, when executed by the at least one data processor, further result in operations that include generating, by a visualization engine, a graphical representation of the selected one or more of the employee descriptors overlaid with the respective powers of those employee descriptors. Optionally, the analytics engine can include a machine learning model trained using a training set of database entries based on portions of the third and fourth sets of database entries, and a test set of database entries based on other portions of the third and fourth sets of database entries.

Non-transitory computer program products (i.e., physically embodied computer program products) are also described that store instructions, which when executed by one or more data processors of one or more computing systems, cause at least one data processor to perform operations herein. Similarly, computer systems are also described that can include one or more data processors and memory coupled to the one or more data processors. The memory can temporarily or permanently store instructions that cause at least one processor to perform one or more of the operations described herein. In addition, process flows can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many technical advantages. For example, the present subject matter can provide automated configuration of disparate employee data from different employers into a common database storage format. Such data aggregation and configuration facilitates analysis and visualization of the data, e.g., using a machine learning model, for example to identify employees who are likely to leave their respective employer in the near future.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system diagram illustrating an example computer system for use in connection with the current subject matter.

FIG. 2 is an example process flow diagram for implementing automated database configurations for analytics and visualization of human resources data.

FIGS. 3A-3C illustrate exemplary graphical user interfaces (GUIs) for visualizing human resources data.

FIG. 4 is a diagram illustrating a sample computing device architecture for implementing various aspects described herein.

FIG. 5 illustrates a sample database configuration.

Like reference symbols in the various drawings indicate like elements.

### DETAILED DESCRIPTION

The systems, computer-readable media, and methods provided herein can provide automated database configuration for analytics and visualization of human resources data. For example, human resources data from multiple companies can be automatically parsed and portions thereof can be extracted into a common database, even though such data can have disparate formats as the companies can store human resources data differently than one another. The human resources data can include, for example, data describing individuals who are employed by a company on a particular date or dates, and can be extracted into the common database periodically, e.g., on a monthly basis. Analytics can be performed on such data, for example so as to identify correlations between certain employee descriptions (e.g., employee age, tenure, or salary) and termination of employees from respective companies, and so as to determine the predictive power of such employee descriptions for predicting employee departure from a company (or employee “flight risk”). Graphical representations of the results of such analytics also can be generated.

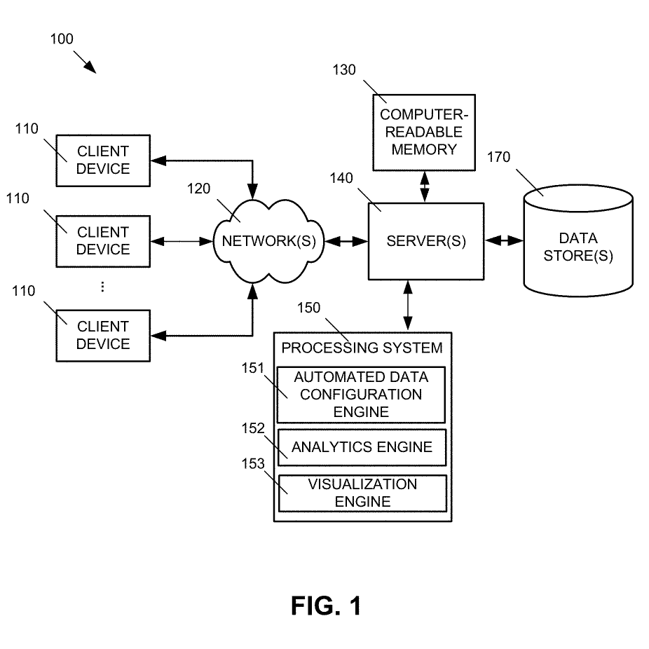

FIG. 1 is a system diagram illustrating an example computer system 100 for use in connection with the certain subject matter. System 100 can include at least one data processor, and memory storing instructions which, when executed by the at least one data processor, result in operations provided herein. In system 100, one or more client devices 110 within an end-user layer of system 100 can be configured to access one or more servers 140 running one or more automated data configuration engines 151, one or more analytics engines 152, and one or more visualization engines 153 on one or more processing systems 150 via one or more networks 120. Alternatively, one or more of client devices 110 and server 140 can be the same computing device, eliminating the need for network 120. One or more servers 140 can access computer-readable memory 130 as well as one or more data stores 170.

System 100 can correspond to a human resources computing system, e.g., a computing system with certain components maintained by one or more companies (which also can be referred to as an employer) and/or maintained by a third party, and can be configured so as to collect, automatically configure, analyze, and visualize data associated with employment of the employees by the employer in a manner such as provided herein. For example, in one exemplary configuration, one or more of client devices 110 corresponds to a company node including a user interface (UI) via which a company can interact with engines running on processing system 150 so as to analyze and visualize human resources data; and server(s) 140 correspond to an analytics hub including a processing system 150 configured to implement automated data configuration engine 151, analytics engine 152, and visualization engine 153 which interface with data store(s) 170 and/or respond to user input at the respective UIs of company nodes 110. Client device(s) 110 (e.g., company nodes) each can include, for example, a respective central processing unit and a computer-readable medium storing instructions for causing the respective central processing unit to perform one or more operations such as provided herein. For example, a computer-readable medium can store instructions causing the central processing unit of client device(s) 110 to receive user input, to interface with automated data configuration engine 151, analytics engine 152, and/or visualization engine 153, and to display graphical representations of the result of analysis of human resources data of the company.

Server(s) 140 can include automated data configuration engine 151 configured so as to receive (e.g., repeatedly receive) and parse human resources data from respective client devices 110, to extract certain data therefrom for generating sets of database entries describing employees employed by the companies on certain dates, and to generate and store employee termination data based on such sets of database entries. Server(s) 140 also can include analytics engine 152 configured so as to analyze the employee termination data, e.g., so as to identify certain employee data that may be highly correlated with employee departures from the company and to quantify the predictive strength of such correlations for future employee departures; and visualization engine 153 configured so as to generate graphical representations of such correlations, and the predictive strengths thereof.

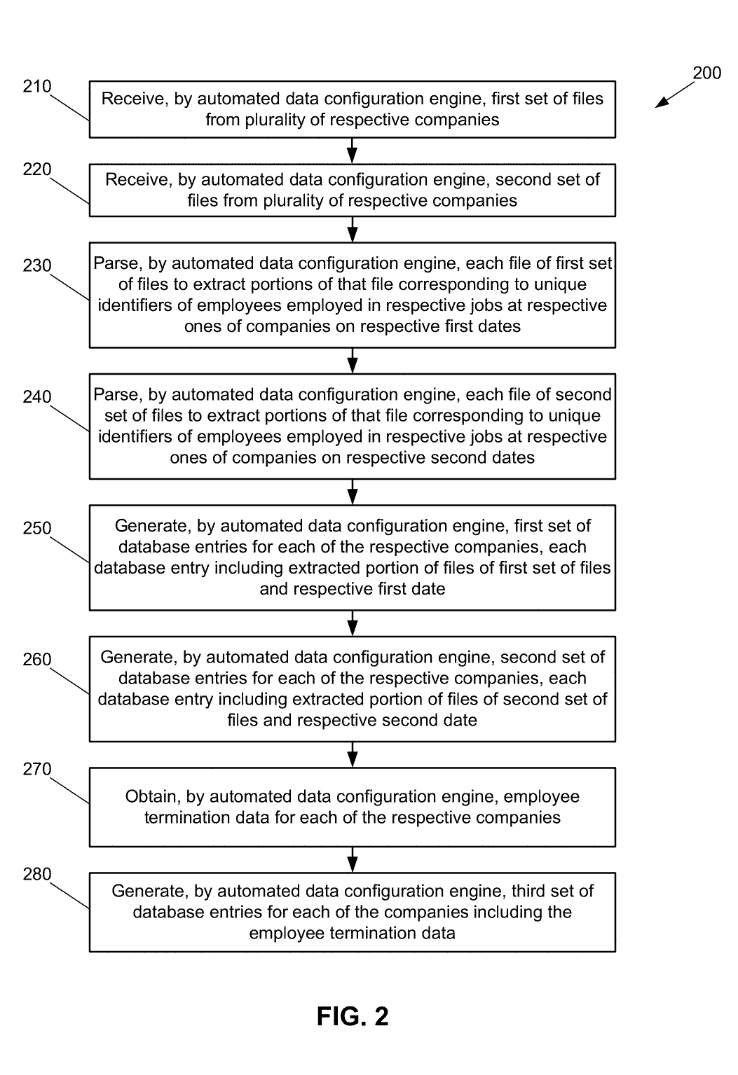

FIG. 2 is an example process flow diagram 200 for implementing automated database configurations for analytics and visualization of human resources data. Although operations performed during implementation of process flow diagram 200 are described with reference to certain components of system 100 illustrated in FIG. 1, it should be appreciated that any of such operations suitably can be performed using any suitable combination of computer hardware and/or software components.

Process flow diagram 200 illustrated in FIG. 2 includes an operation of receiving, by an automated data configuration engine operating on one or more data processors, a first set of files from a plurality of respective companies (operation 210) and an operation of receiving, by the automated data configuration engine, a second set of files from the plurality of respective companies (operation 220). For example, automated data configuration engine 151 illustrated in FIG. 1 can receive a file from a first client device 110 (e.g., via network 120) at one time and another file from the first client device 110 at another time, can receive a file from a second client device 110 at one time and another file from the second client device 110 at another time, and so on. The times at which automated data configuration engine 151 receives the various files from the various client devices 110 need not be the same as one another.

The first and second sets of files can include human resources data for each of the companies, optionally on different dates than one another. For example, the files of the first set of files respectively can include unique identifiers for employees employed in respective jobs at respective ones of the companies on respective first dates, and the files of the second set of files respectively can include unique identifiers for employees employed in respective jobs at respective ones of the companies on respective second dates. Note that based on changes in employment (which also can be referred to as headcount) over time at the company, the files received from a given company at different times than one another can reflect the departure of employees from that company, e.g., between one date or dates and another date or dates. Additionally, note that the human resources data received from one company may not necessarily be formatted in the same way as the human resources data received from another company. For example, at least some of the files of the first set of files can have different formats than one another and/or at least some of the files of the second set of files have different formats than one another. Optionally, files of the first and second sets of files can include flat files, e.g., files including unstructured tables of human resources data. Within such a flat file, an arbitrary column can include unique identifiers for employees employed in respective jobs at the company from which that file is received. Additionally, or alternatively, the files of the first and second sets of files can include multidimensional data stored in any suitable format(s), which can be referred to as a cube file.

Optionally, the file (e.g., flat file or cube file) can include a date on which all of those employees were employed by the company, or can include a column or other format of dates on which each of those respectively employed by the company. Alternatively, the date or dates on which the employees were employed by the company can be separately transmitted to automated data engine 151 or otherwise known by the automated data engine. For example, automated data engine 151 can treat the date on which it receives the file as being the date on which the employees are respectively employed.

Additionally, or alternatively, the file optionally can also include one or more other employee descriptors, such as an identifier of the job of that employee (e.g., a value representing the employee's job or a job family of that job), an age of that employee, a tenure of that employee at the respective company (e.g., how long that employee has worked at the company, or in the job), a salary of that employee, an employment type of that employee (e.g., full time or part time), and a potential rating of that employee (e.g., a value representing whether the employee is considered to have a relatively high potential for progressing in the company, a relatively average potential, or a relatively low potential). As described in greater below, analytics can be performed so as to identify correlations between such employee descriptors and employee departure from respective companies. Such employee descriptors can be provided within the file, e.g., as respective columns within a flat file or cube file, or otherwise transmitted to automated data configuration engine 151.

Process flow diagram 200 illustrated in FIG. 2 also includes respective operations of parsing, by the automated data configuration engine, each file of the first set of files to extract portions of that file corresponding to the unique identifiers of employees for the employees employed in the respective jobs at the respective ones of the companies on the respective first dates (operation 230), and each file of the second set of files to extract portions of that file corresponding to the unique identifiers of employees for the employees employed in the respective jobs at the respective ones of the companies on the respective second dates (operation 240). For example, automated data configuration engine 151 illustrated in FIG. 1 can be configured so as to identify the unique identifiers of the employees within the file received from a given company, regardless of the particular location of those identifiers within the file. Illustratively, the employee identifiers (e.g., Emp_ID) can be stored in a metadata table with all other column names of the database table. The corresponding employment date (e.g., Effective_Date) can be generated each month for each employee in a company when the employee data is refreshed. Automated data configuration engine 151 illustrated in FIG. 1 also can be configured so as to extract the identified unique identifiers, e.g., by selectively obtaining those identifiers out of the file received from the company.

Process flow diagram 200 illustrated in FIG. 2 also includes respective operations of generating, by the automated data configuration engine, a first set of database entries for each of the respective companies (operation 250) and generating a second set of database entries for each of the respective companies (operation 260). Each database entry of the first set of database entries can include an extracted portion of the files of the first set of files and the respective first date, and each database entry of the second set of database entries can include an extracted portion of the files of the second set of files and the respective second date. For example, automated data configuration engine 151 illustrated in FIG. 1 can generate one or more tables stored in a relational database within data store(s) 170, such as a SQL database, and can populate respective columns of the table(s) with the extracted portions of the first and second sets of files and the first and second dates. Alternatively, automated data configuration engine 151 can populate columns of previously existing table(s) with the extracted portions of the first and second sets of files and the first and second dates. In one exemplary configuration, data store(s) 170 includes a plurality of tables generated and/or populated by automated data configuration engine 151. Each table of the plurality of tables can correspond to a company and can include a first column including the extracted unique identifiers of the company's employees on a first date or dates, a second column including the first date or dates, a third column including the extracted unique identifiers of the company's employees on a second data or dates, and a fourth column including the second date or dates. The first, second, third, and fourth columns can be located in the same table positions for each respective company.

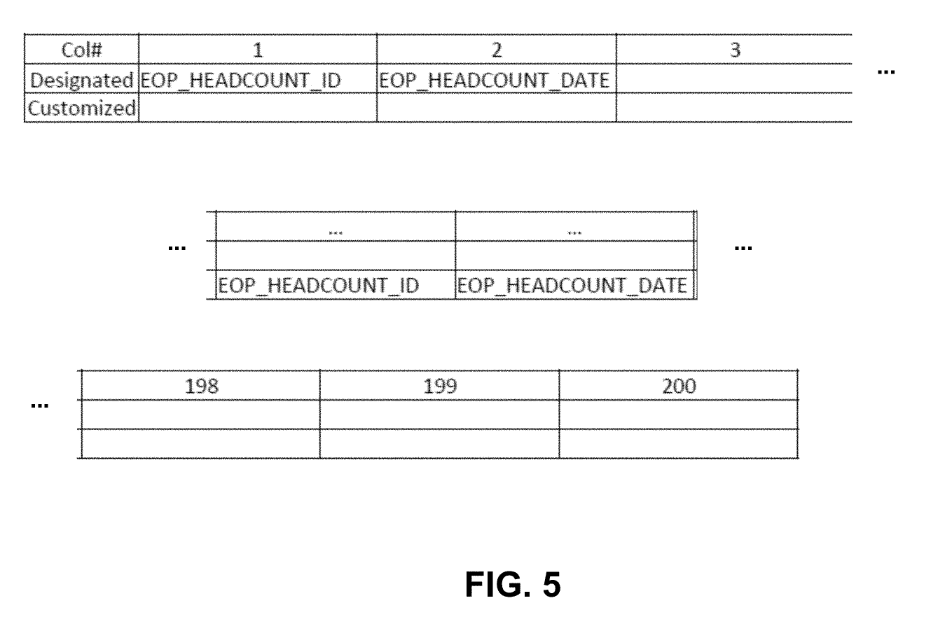

In some configurations, each company can have a designated database table that includes respective columns for unique identifiers of employees and dates that are located in positions that are different from those in another company's database table. The automatic data configuration engine can standardize the column positions so as to facilitate further processing. As an example, Company A may have its unique identifiers of employees and dates positioned in columns 20 and 21, while company B may have the two columns located in columns 10 and 35. The automated data configuration engine can re-locate the two columns to a fixed location for both companies, e.g., columns 1 and 2 in a manner such as illustrated in FIG. 5, which illustrates a sample database configuration.

Optionally, in configurations in which the files received from the companies include one or more employee descriptors such as described herein or in which automated data configuration 151 otherwise receives such descriptors, the automated data configuration engine can be configured so as to generate a set of database entries for each of the companies that includes the employee descriptors. For example, automated data configuration engine 151 can generate, within a table corresponding to a company, columns including respective ones of the employee descriptors (e.g., a column for employee age, another column for employee salary, and the like). Note that employee descriptors can change over time, e.g., as an employee's salary, age, or employment status changes. Automated data configuration engine 151 can generate different database entries for the employee descriptors corresponding to different times than one another, e.g., can generate in a company's table a column or set of columns corresponding to employee descriptors at the first date or dates, and can generate in the company's table another column or set of columns corresponding to employee descriptors at the second date or dates.

Process flow diagram 200 illustrated in FIG. 2 also includes an operation of obtaining, by the automated data configuration engine, employee termination data for each of the respective companies (operation 270). In some configurations, the termination date is generated (e.g., by the company) when an employee has been officially terminated in a company, and such termination date is provided within a file to the automated data configuration engine in a manner similar to that of the first and second files and parsed from such a file. As another option, the automated data configuration engine can generate the employee termination data based on differences between the first and second sets of database entries for that company. For example, based upon the unique identifiers for respective employees being included in the first set of database entries for a given company, but not in the second set of database entries for that company, automated data configuration engine 151 can determine that those employees left the company between the first and second dates and thus have been terminated (whether the employee left voluntarily or was fired), and can generate employee termination data that includes the unique identifiers for those (former) employees.

Process flow diagram 200 illustrated in FIG. 2 also includes an operation of generating, by the automated data configuration engine, a third set of database entries for each of the companies (operation 280). Each database entry of the third set of database entries can include the employee termination data of the respective company, e.g., such as generated at operation 270. For example, automated data configuration engine 151 illustrated in FIG. 1 can store the third set of database entries in data store(s) 170, e.g., in the same or in a different database than in which the first and second sets of database entries are stored.

System 100 illustrated in FIG. 1 can be configured so as to perform additional analytics based on the third set of database entries corresponding to employee termination data, and optionally also based on a fourth set of database entries corresponding to one or more employee descriptors which can be generated such as described elsewhere herein. For example, processing system 150 can include analytics engine 152 configured to identify correlations between employee departures and one or more employee descriptors, e.g., for use in predicting whether future employees may leave the company. In one example, analytics engine 152 can select, based on the third and fourth sets of database entries, one or more of the employee descriptors as being relatively highly correlated with employee departure from the company. For example, analytics engine 152 can include a machine learning model that is trained using a training set of database entries based on portions of the third and fourth sets of database entries, and a test set of database entries based on other portions of the third and fourth sets of database entries. The thus-trained machine learning model can identify correlations between the third and fourth sets of database entries, e.g., can identify correlations between employee termination data and one or more employee descriptors, and can select the employee descriptor(s) that are most highly correlated with employee termination. Analytics engine 152 also can be configured so as to generate, based on the third and fourth sets of database entries, a value representing a power of the one or more employee descriptors for predicting employee departure from the company. Such value also can be referred to as a “predictive power” of the respective employee descriptor, the employee descriptor can be referred to as an “influencer” of employee termination, and the likelihood of employee termination can be referred to as a “target” or a “target variable.” The employee descriptor(s) that analytics engine 152 selects as being most highly correlated with employee departures, as well as the predictive power of those descriptor(s), suitably can be visualized. For example, processing system 150 can include visualization engine 153 configured so as to receive employee descriptor(s) and predictive powers thereof from analytics engine 152, and to generate graphical representations thereof, e.g., at a graphical user interface of a client device 110. Illustratively, visualization engine 153 can generate a graphical representation of the employee descriptor(s) overlaid with the respective powers of those employee descriptors.

In some configurations, the predictive power of an influencer (such as an employee descriptor), or the proportion of the target's variability, can be a value between 0 and 1. The higher the value, the more accurately the influencer can predict the target (such as employee termination). Each influencer can include a set of influencer categories. For example, the influencer (employee descriptor) of employee age can have categories such as 20-29 years, 30-39 years, and the like, and the influencer (employee descriptor) of employment type can have categories such as full-time and part-time. The predictive power of the influencer is defined by the aggregated contributions of the categories. The individual category contribution is measured by the category importance, which can be defined as the overall influence by a category on the target variable. In turn, the category importance can be defined by the category profit and the category frequency. The category profit can be defined as a measure of information gain over random guess; a positive profit exerts a positive influence on the target variable, and a negative profit exerts a negative influence on the target variable. The category frequency can represent the number of items included in a particular category.

The predictive power of an influencer can correspond to the capacity (or the proportion of the target's variability) to explain the target variable, e.g., likelihood of employee termination. The predictive power is a value between 0 (corresponding to no model) and 1 (corresponding to a perfect model), in which the higher the value, the greater the capacity. Each employee descriptor (e.g., age, employment status, or other employee descriptors such as provided herein) can contribute to a part of the overall predictive power. The higher the significance, the more the employee descriptor can explain the target variable, e.g., likelihood of employee termination. In one nonlimiting example, age can have a significance of 0.1795, meaning that age has 17.95% of the predictive power. The significance of all influencers can sum to 1 (corresponding to 100% of the predictive power). Each influencer can include, or can consist of, a set of influencer categories, each of which is measured by category importance, e.g., a value (positive or negative) representing the contribution of the significance of the influencer. Category importance can have two components: net profit and frequency. Net profit can represent the “lift” for the target variable, and frequency can correspond to the percentage of elements in the category. For example, ages between 35 and 44 can have a positive contribution of 0.1 and a population of 19.1%; ages between 20 and 30 can have a negative contribution of −0.05 and a population of 33.1%; and the sum of the category profit can be equal to 0.

In aspects provided herein, influencers and their categories can be combined into a single view (e.g., shown in a GUI of client device 110) seamlessly so as to provide visual effectiveness. Illustratively, an influencer and its categories can be combined. Each influencer (I) can be defined by its constituent influencer category (IC). Each IC can have two components, category profit (CP) and category frequency (CF). CP can be a measure of “lift” or “gain” in prediction accuracy, and CF can be the element count of the category. The two quantities CP and CF define the category importance (CI of the category). CP and CF can be related non-monotonically, For example, a high profit category may have a low category frequency, and vice versa. The two quantities can be visualized together for a category, e.g., by visualization engine 153. For visualization, CI can be used for positioning chart elements; for example, the higher the measure, the more prominent the position of the chart element can be (e.g., column chart, or horizontal bar). CI can be expressed as:

CI=CP*CF/NC (1)

where CP corresponds to normal profit and CF corresponds to the bin frequency, and NC is a normalization constant. NC can be expressed as:

NC=TF*(1−TF) (2)

where TF is the target frequency, which is the overall count of the target variable regardless of the category.

CP is a measure of information gain, or Profit, for a category C on predicting the target variable over a random guess. For visualization, CP can be used to highlight the contributions, e.g., with color and/or shading. In some configurations, only the CP with the highest gain is displayed. CP for a category C can be expressed as:

CP(C)=Profit(TC2)*P(TC2|C)+Profit(TC1)*P(TC1|C) (3)

where

Profit(TC1)*proba(TC1)+Profit(TC2)*proba(TC2) (4)

and where TC1 corresponds to target class 1, TC2 corresponds to target class 2, Profit corresponds to measure of information gain, P corresponds to conditional probability, C corresponds to category, and proba corresponds to probability measure.

Category frequency (CF) represents the number of items included in a category C. For visualization, CF can be used to mark the proportion on the chart element. CF for a category C can be expressed as

CF(C)=# of C elements/total # of elements (5)

where the total # of element is a union of all elements of all categories.

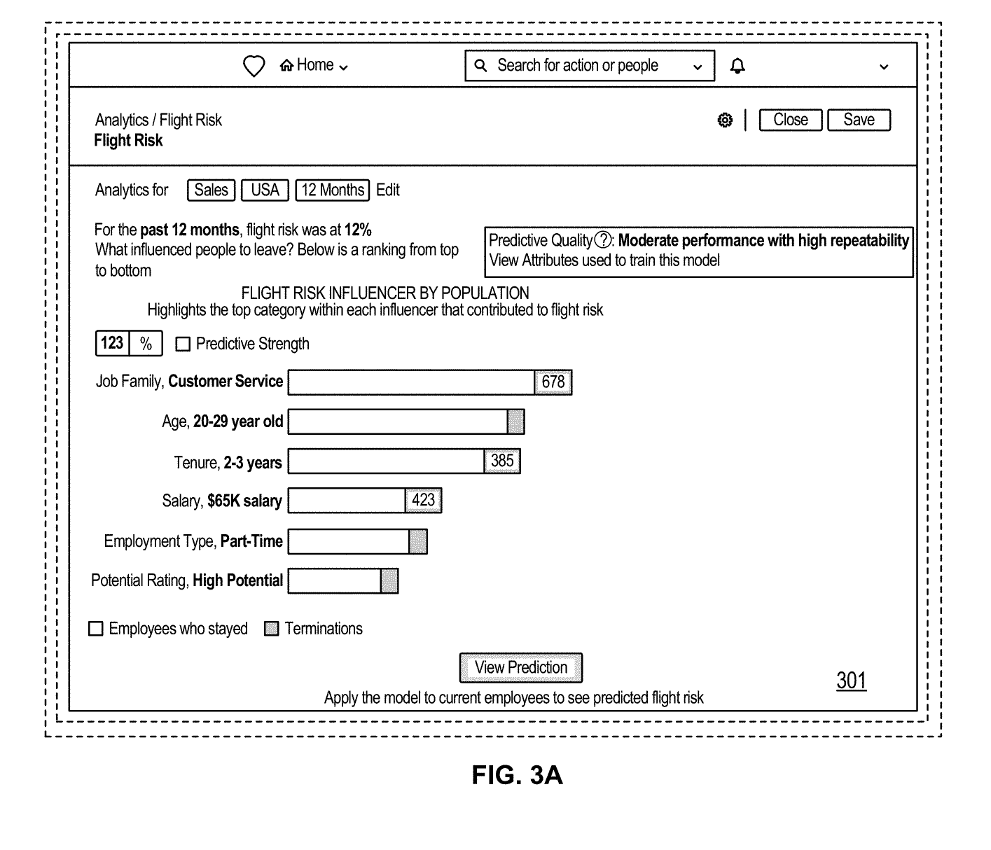

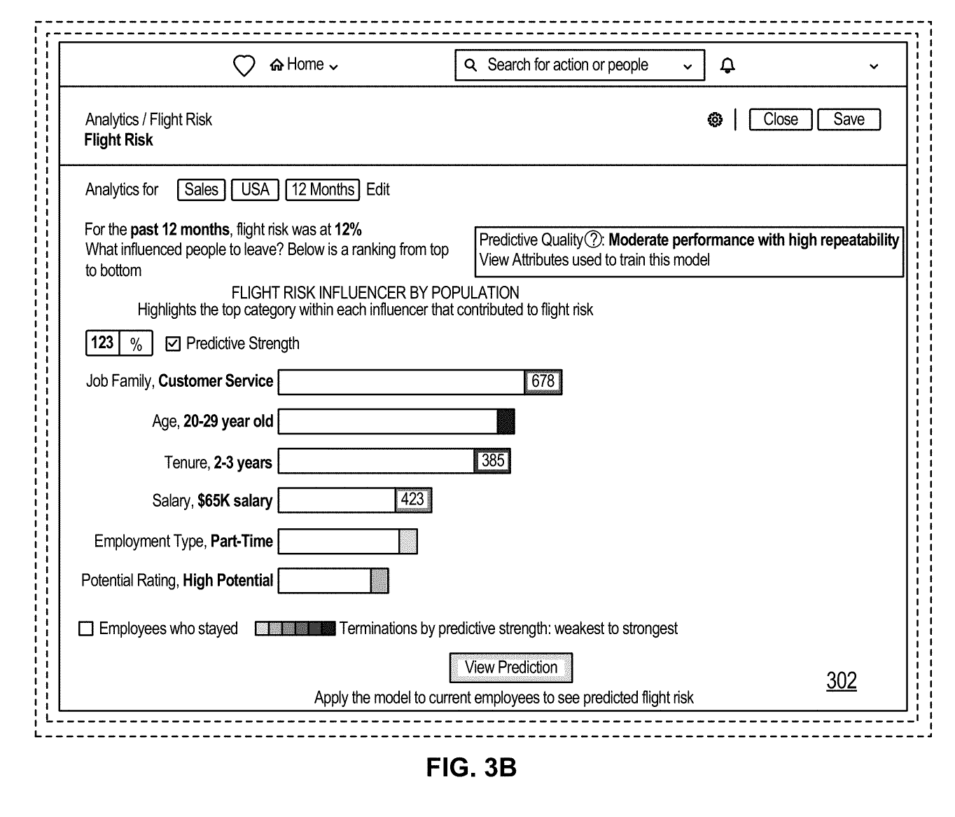

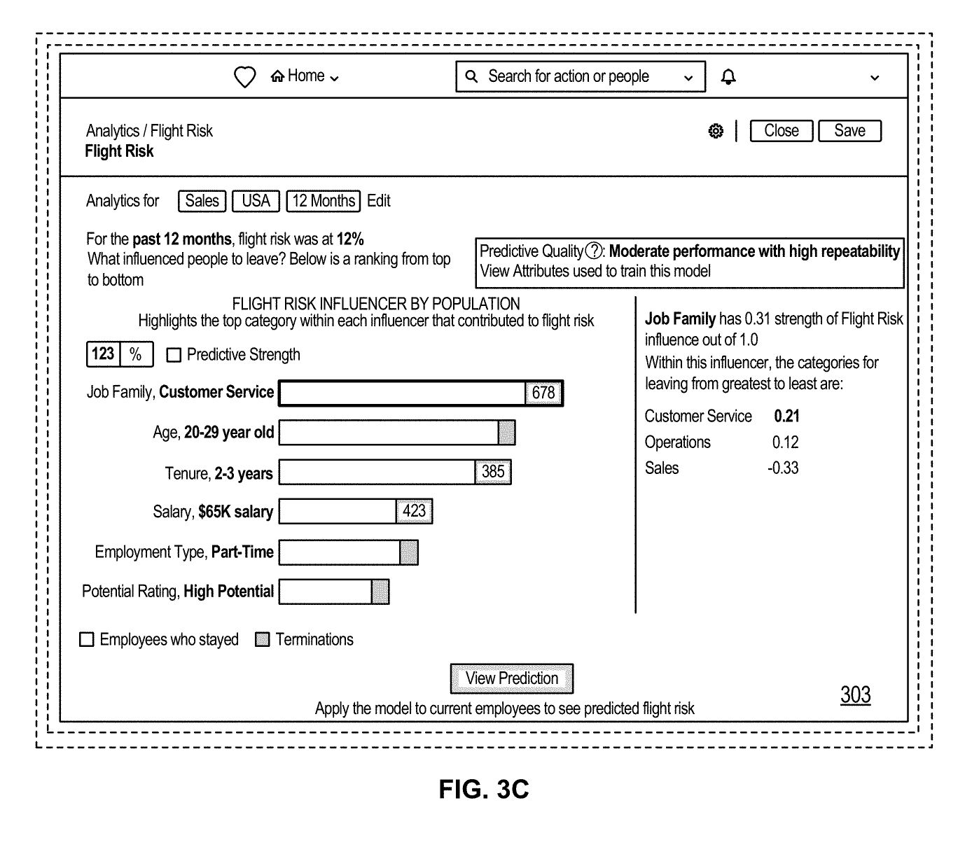

For example, FIGS. 3A-3C illustrate exemplary graphical user interfaces (GUIs) for visualizing human resources data, e.g., such as respectively can be generated, analyzed, and visualized by automated data configuration engine 151, analytics engine 152, and visualization engine 153 of processing system 150 illustrated in FIG. 1. FIG. 3A illustrates a non-limiting example of a GUI 301 that includes influencers with top categories and respective category populations. For example, in GUI 301, the population of the top category “customer service” of the influencer “job family” is represented as a horizontal bar, of which the number of employee terminations are shown as a distinct (e.g., darkened) portion of that bar, optionally together with a numerical value (here 678). Additionally, in GUI 301, the population of the top category “20-29 year old” of the influencer “age” is represented as a horizontal bar, of which the number of employee terminations are shown as a distinct (e.g., darkened) portion of that bar, optionally together with a numerical value (here not shown). Additionally, in GUI 301, the population of the top category “2-3 years” of the influencer “tenure” is represented as a horizontal bar, of which the number of employee terminations are shown as a distinct (e.g., darkened) portion of that bar, optionally together with a numerical value (here 385). Additionally, in GUI 301, the population of the top category “$65K salary” of the influencer “salary” is represented as a horizontal bar, of which the number of employee terminations are shown as a distinct (e.g., darkened) portion of that bar, optionally together with a numerical value (here 423). Additionally, in GUI 301, the population of the top category “part-time” of the influencer “employment type” is represented as a horizontal bar, of which the number of employee terminations are shown as a distinct (e.g., darkened) portion of that bar, optionally together with a numerical value (here not shown). Additionally, in GUI 301, the population of the top category “high potential” of the influencer “potential rating” is represented as a horizontal bar, of which the number of employee terminations are shown as a distinct (e.g., darkened) portion of that bar, optionally together with a numerical value (here not shown). In this example, within each horizontal bar, the number of employee terminations can be shown in the same color or shade as one another.

FIG. 3B illustrates a non-limiting example of a GUI 302 that includes influencers with top categories, respective category populations, and category profits. For example, in GUI 302, the populations of the top categories of each influencer again are respectively represented as horizontal bars, of which the number of employee terminations are shown as a distinct (e.g., darkened) portion of that bar, optionally together with a numerical value. GUI 302 also represents the category profit (CP) of each top category, for example, by showing the horizontal bar portion corresponding to the number of employee terminations in different colors or shades than one another, where the color or shade corresponds to the CP for that category. For example, in GUI 302, it can be seen that shading from lightest to darkest corresponds to predictive strength of the category for employee terminations, from weakest to strongest. In this example, the category “part-time employment” of influencer “employment type” had the weakest predictive strength, and so the horizontal bar portion corresponding to the number of employee terminations for that category is shown with the lightest shading, while the category “20-29 year old” of influencer “age” had the greatest predictive strength, and so the horizontal bar portion corresponding to the number of employee terminations for that category is shown with the darkest shading. Other top categories shown in GUI 302 had predictive strengths between the weakest and the strongest, and thus respective shadings in between the lightest and darkest shading for the horizontal bar portion corresponding to the number of employee terminations for that category. In this example, the user can select to show the respective predictive strengths by checking the “Predictive Strength” box in the GUI.

FIG. 3C illustrates a non-limiting example of a GUI 303 that includes influencers with top categories, respective category populations, and additional details. For example, in GUI 303, the populations of the top categories of each influencer again are respectively represented as horizontal bars, of which the number of employee terminations are shown as a distinct (e.g., darkened) portion of that bar, optionally together with a numerical value. GUI 303 optionally can include shadings representing the category profit (CP) of each top category similarly as in GUI 302, although such shadings are omitted from GUI 303 for simplicity. GUI 303 also can include additional details, such as alphanumeric representations of the predictive strength of the influencer and/or the category profit of different categories of each influencer. For example, user selection (e.g., within GUI 303 displayed at client device 110) of an influencer or the top category thereof (e.g., selection of the horizontal bar for that influencer) thereof causes the GUI to display, within an area of the GUI separate from the horizontal bars representing the top categories of influencers, alphanumeric information providing additional details about the predictive strength of the influencer as well as the category profit of one or more categories of that influencer. Illustratively, user selection of the top category “customer service” of influencer “job family” causes GUI 303 to generate an area stating that “Job Family has 0.31 strength of Flight Risk influence out of 1.0,” and listing, within that influencer, categories for leaving from greatest to least together with the category profit of those categories (here, customer service (0.21), operations (0.12), and sales (−0.33)).

Accordingly, system 100 can include at least one data processor (e.g., processor(s) of client devices 110 and processing system 150) and memory (e.g., non-transitory computer-readable media of client devices 110 and processing system 150) storing instructions which, when executed by the at least one data processor, result in operations including receiving, by an automated data configuration engine, a first set of files from a plurality of respective companies. The files of the first set of files respectively can include unique identifiers for employees employed in respective jobs at respective ones of the companies on respective first dates, and at least some of the files of the first set of files have different formats than one another. The operations also can include receiving, by the automated data configuration engine, a second set of files from the plurality of respective companies. The files of the second set of files respectively can include unique identifiers for employees employed in respective jobs at respective ones of the companies on respective second dates, and at least some of the files of the second set of files have different formats than one another.

The operations also can include parsing, by the automated data configuration engine, each file of the first set of files to extract portions of that file corresponding to the unique identifiers of employees for the employees employed in the respective jobs at the respective ones of the companies on the respective first dates. The operations also can include parsing, by the automated data configuration engine, each file of the second set of files to extract portions of that file corresponding to the unique identifiers of employees for the employees employed in the respective jobs at the respective ones of the companies on the respective second dates. The operations also can include generating, by the automated data configuration engine, a first set of database entries for each of the respective companies. Each database entry of the first set of database entries can include an extracted portion of the files of the first set of files and the respective first date. The operations also can include generating, by the automated data configuration engine, a second set of database entries for each of the respective companies. Each database entry of the second set of database entries can include an extracted portion of the files of the second set of files and the respective second date. The operations also can include generating, by the automated data configuration engine, employee termination data for each of the respective companies based on differences between the first and second sets of database entries for that company. The operations also can include generating, by the automated data configuration engine, a third set of database entries for each of the companies. Each database entry of the third set of database entries can include the employee termination data of the respective company.

Accordingly, among other things, the present systems, methods, and computer-readable media can generate, from disparately formatted human resources data from different companies, data regarding employee termination; can perform analytics thereon; and can visualize the results of the analytics in an easy to understand, graphical manner providing significant amounts of useful information.

One or more aspects or features of the subject matter described herein can be realized in digital electronic circuitry, integrated circuitry, specially designed application specific integrated circuits (ASICs), field programmable gate arrays (FPGAs), computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, can include machine instructions for a programmable processor, and/or can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, solid-state storage devices, memory, and Programmable Logic Devices (PLDs), used to provide machine instructions and/or data to a programmable data processor, including a machine-readable medium that receives machine instructions as a computer-readable signal. The term “computer-readable signal” refers to any signal used to provide machine instructions and/or data to a programmable data processor. The computer-readable medium can store such machine instructions non-transitorily, such as for example as would a non-transient solid-state memory or a magnetic hard drive or any equivalent storage medium. The computer-readable medium can alternatively or additionally store such machine instructions in a transient manner, such as for example as would a processor cache or other random access memory associated with one or more physical processor cores.

The computer components, software modules, functions, data stores and data structures described herein can be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality can be located on a single computer or distributed across multiple computers depending upon the situation at hand.

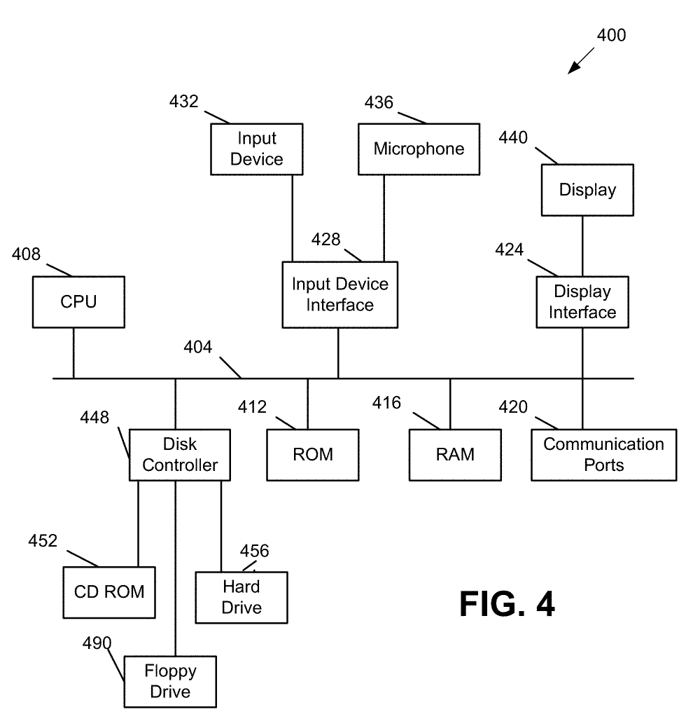

FIG. 4 is a diagram 400 illustrating a sample computing device architecture for implementing various aspects described herein, such as any aspect that can be processed using server(s) 140, client device(s) 110, or processing system 150 executing automated data configuration engine 151, analytics engine 152, and/or visualization engine 153. A bus 404 can serve as the information highway interconnecting the other illustrated components of the hardware. A processing system 408 labeled CPU (central processing unit) (e.g., one or more computer processors/data processors at a given computer or at multiple computers), can perform calculations and logic operations required to execute a program. A non-transitory processor-readable storage medium, such as read only memory (ROM) 412 and random access memory (RAM or buffer) 416, can be in communication with the processing system 408 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 448 can interface one or more optional disk drives to the system bus 404. These disk drives can be external or internal floppy disk drives such as 460, external or internal CD-ROM, CD-R, CD-RW or DVD, or solid state drives such as 452, or external or internal hard drives 456. As indicated previously, these various disk drives 452, 456, 460 and disk controllers are optional devices. The system bus 404 can also include at least one communication port 420 to allow for communication with external devices either physically connected to the computing system or available externally through a wired or wireless network. In some cases, the communication port 420 includes or otherwise comprises a network interface.

To provide for interaction with a user, the subject matter described herein can be implemented on a computing device having a display device 440 (e.g., a CRT (cathode ray tube) or LCD (liquid crystal display) monitor) for displaying information obtained from the bus 404 to the user and an input device 432 such as keyboard and/or a pointing device (e.g., a mouse or a trackball) and/or a touchscreen by which the user can provide input to the computer. Other kinds of input devices 432 can be used to provide for interaction with a user as well; for example, feedback provided to the user can be any form of sensory feedback (e.g., visual feedback, auditory feedback by way of a microphone 436, or tactile feedback); and input from the user can be received in any form, including acoustic, speech, or tactile input. In the input device 432 and the microphone 436 can be coupled to and convey information via the bus 404 by way of an input device interface 428. Other computing devices, such as dedicated servers, can omit one or more of the display 440 and display interface 424, the input device 432, the microphone 436, and input device interface 428.

In the descriptions above and in the claims, phrases such as “at least one of” or “one or more of” can occur followed by a conjunctive list of elements or features. The term “and/or” can also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving, by an automated data configuration engine operating on one or more data processors, a first set of files from a plurality of respective companies,
the files of the first set of files respectively comprising unique identifiers for employees employed in respective jobs at respective ones of the companies on respective first dates, and
wherein at least some of the files of the first set of files have different formats than one another;
receiving, by the automated data configuration engine, a second set of files from the plurality of respective companies,
the files of the second set of files respectively comprising unique identifiers for employees employed in respective jobs at respective ones of the companies on respective second dates, and
wherein at least some of the files of the second set of files have different formats than one another;
parsing, by the automated data configuration engine, each file of the first set of files to extract portions of that file corresponding to the unique identifiers of employees for the employees employed in the respective jobs at the respective ones of the companies on the respective first dates;
parsing, by the automated data configuration engine, each file of the second set of files to extract portions of that file corresponding to the unique identifiers of employees for the employees employed in the respective jobs at the respective ones of the companies on the respective second dates;
generating, by the automated data configuration engine, a first set of database entries for each of the respective companies, each database entry of the first set of database entries comprising an extracted portion of the files of the first set of files and the respective first date;
generating, by the automated data configuration engine, a second set of database entries for each of the respective companies, each database entry of the second set of database entries comprising an extracted portion of the files of the second set of files and the respective second date;
obtaining, by the automated data configuration engine, employee termination data for each of the respective companies; and
generating, by the automated data configuration engine, a third set of database entries for each of the companies, each database entry of the third set of database entries comprising the employee termination data of the respective company.

2. The method of claim 1, wherein files of the first and second sets of files comprise flat files.

3. The method of claim 1, wherein the first set of database entries for each company respectively comprises a first column comprising the unique identifiers for employees employed by that company on the respective first dates and a second column comprising the respective first dates,
wherein the second set of database entries for each company respectively comprises a third column comprising the unique identifiers for employees employed by that company on the respective second dates and a fourth column comprising the respective second dates, and
wherein the first, second, third, and fourth columns are located in the same positions for each respective company.

4. The method of claim 1, wherein at least some files of the first and second files further comprise, for each employee, one or more employee descriptors selected from the group consisting of an identifier of the job of that employee, an age of that employee, a tenure of that employee at the respective company, a salary of that employee, an employment type of that employee, and a potential rating of that employee,
the method further comprising generating, by the automated data configuration engine, a fourth set of database entries for each of the companies, each database entry of the fourth set of database entries comprising one of the one or more employee descriptors.

5. The method of claim 4, further comprising:
selecting, by an analytics engine operating on one or more data processors, based on the third and fourth sets of database entries, one or more of the employee descriptors as being relatively highly correlated with employee departure from the company; and
generating, by the analytics engine, based on the third and fourth sets of database entries, a value representing a power of the one or more employee descriptors for predicting employee departure from the company.

6. The method of claim 5, further comprising generating, by a visualization engine operating on one or more data processors, a graphical representation of the selected one or more of the employee descriptors overlaid with the respective powers of those employee descriptors.

7. The method of claim 5, wherein the analytics engine comprises a machine learning model trained using a training set of database entries based on portions of the third and fourth sets of database entries, and a test set of database entries based on other portions of the third and fourth sets of database entries.

8. A computer system comprising:
at least one data processor; and
memory storing instructions which, when executed by the at least one data processor, result in operations comprising:
receiving, by an automated data configuration engine, a first set of files from a plurality of respective companies,
the files of the first set of files respectively comprising unique identifiers for employees employed in respective jobs at respective ones of the companies on respective first dates, and
wherein at least some of the files of the first set of files have different formats than one another;
receiving, by the automated data configuration engine, a second set of files from the plurality of respective companies,
the files of the second set of files respectively comprising unique identifiers for employees employed in respective jobs at respective ones of the companies on respective second dates, and
wherein at least some of the files of the second set of files have different formats than one another;
parsing, by the automated data configuration engine, each file of the first set of files to extract portions of that file corresponding to the unique identifiers of employees for the employees employed in the respective jobs at the respective ones of the companies on the respective first dates;
parsing, by the automated data configuration engine, each file of the second set of files to extract portions of that file corresponding to the unique identifiers of employees for the employees employed in the respective jobs at the respective ones of the companies on the respective second dates;
generating, by the automated data configuration engine, a first set of database entries for each of the respective companies, each database entry of the first set of database entries comprising an extracted portion of the files of the first set of files and the respective first date;
generating, by the automated data configuration engine, a second set of database entries for each of the respective companies, each database entry of the second set of database entries comprising an extracted portion of the files of the second set of files and the respective second date;
obtaining, by the automated data configuration engine, employee termination data for each of the respective companies; and
generating, by the automated data configuration engine, a third set of database entries for each of the companies, each database entry of the third set of database entries comprising the employee termination data of the respective company.

9. The computer system of claim 8, wherein files of the first and second sets of files comprise flat files.

10. The computer system of claim 8, wherein the first set of database entries for each company respectively comprises a first column comprising the unique identifiers for employees employed by that company on the respective first dates and a second column comprising the respective first dates, wherein the second set of database entries for each company respectively comprises a third column comprising the unique identifiers for employees employed by that company on the respective second dates and a fourth column comprising the respective second dates, and
wherein the first, second, third, and fourth columns are located in the same positions for each respective company.

11. The computer system of claim 8, wherein at least some files of the first and second files further comprise, for each employee, one or more employee descriptors selected from the group consisting of an identifier of the job of that employee, an age of that employee, a tenure of that employee at the respective company, a salary of that employee, an employment type of that employee, and a potential rating of that employee,
wherein the instructions, when executed by the at least one data processor, further result in operations comprising generating, by the automated data configuration engine, a fourth set of database entries for each of the companies, each database entry of the fourth set of database entries comprising one of the one or more employee descriptors.

12. The computer system of claim 11, wherein the instructions, when executed by the at least one data processor, further result in operations comprising:
selecting, by an analytics engine, based on the third and fourth sets of database entries, one or more of the employee descriptors as being relatively highly correlated with employee departure from the company; and
generating, by the analytics engine, based on the third and fourth sets of database entries, a value representing a power of the one or more employee descriptors for predicting employee departure from the company.

13. The computer system of claim 12, wherein the instructions, when executed by the at least one data processor, further result in operations comprising generating, by a visualization engine, a graphical representation of the selected one or more of the employee descriptors overlaid with the respective powers of those employee descriptors.

14. The computer system of claim 12, wherein the analytics engine comprises a machine learning model trained using a training set of database entries based on portions of the third and fourth sets of database entries, and a test set of database entries based on other portions of the third and fourth sets of database entries.

15. A non-transitory computer-readable medium storing instructions which, when executed by at least one data processor of a computer system, result in operations comprising:
receiving, by an automated data configuration engine, a first set of files from a plurality of respective companies,
the files of the first set of files respectively comprising unique identifiers for employees employed in respective jobs at respective ones of the companies on respective first dates, and
wherein at least some of the files of the first set of files have different formats than one another;
receiving, by the automated data configuration engine, a second set of files from the plurality of respective companies,
the files of the second set of files respectively comprising unique identifiers for employees employed in respective jobs at respective ones of the companies on respective second dates, and
wherein at least some of the files of the second set of files have different formats than one another;
parsing, by the automated data configuration engine, each file of the first set of files to extract portions of that file corresponding to the unique identifiers of employees for the employees employed in the respective jobs at the respective ones of the companies on the respective first dates;
parsing, by the automated data configuration engine, each file of the second set of files to extract portions of that file corresponding to the unique identifiers of employees for the employees employed in the respective jobs at the respective ones of the companies on the respective second dates;
generating, by the automated data configuration engine, a first set of database entries for each of the respective companies, each database entry of the first set of database entries comprising an extracted portion of the files of the first set of files and the respective first date;
generating, by the automated data configuration engine, a second set of database entries for each of the respective companies, each database entry of the second set of database entries comprising an extracted portion of the files of the second set of files and the respective second date;
obtaining, by the automated data configuration engine, employee termination data for each of the respective companies; and
generating, by the automated data configuration engine, a third set of database entries for each of the companies, each database entry of the third set of database entries comprising the employee termination data of the respective company.

16. The computer-readable medium of claim 15, wherein files of the first and second sets of files comprise flat files.

17. The computer-readable medium of claim 15, wherein the first set of database entries for each company respectively comprises a first column comprising the unique identifiers for employees employed by that company on the respective first dates and a second column comprising the respective first dates,
wherein the second set of database entries for each company respectively comprises a third column comprising the unique identifiers for employees employed by that company on the respective second dates and a fourth column comprising the respective second dates, and
wherein the first, second, third, and fourth columns are located in the same positions for each respective company.

18. The computer-readable medium of claim 15, wherein at least some files of the first and second files further comprise, for each employee, one or more employee descriptors selected from the group consisting of an identifier of the job of that employee, an age of that employee, a tenure of that employee at the respective company, a salary of that employee, an employment type of that employee, and a potential rating of that employee,
wherein the instructions, when executed by the at least one data processor, further result in operations comprising generating, by the automated data configuration engine, a fourth set of database entries for each of the companies, each database entry of the fourth set of database entries comprising one of the one or more employee descriptors.

19. The computer-readable medium of claim 18, wherein the instructions, when executed by the at least one data processor, further result in operations comprising:
selecting, by an analytics engine, based on the third and fourth sets of database entries, one or more of the employee descriptors as being relatively highly correlated with employee departure from the company; and
generating, by the analytics engine, based on the third and fourth sets of database entries, a value representing a power of the one or more employee descriptors for predicting employee departure from the company.

20. The computer-readable medium of claim 18, wherein the instructions, when executed by the at least one data processor, further result in operations comprising generating, by a visualization engine, a graphical representation of the selected one or more of the employee descriptors overlaid with the respective powers of those employee descriptors.
